(19) United States
(12) Patent Application Publication
(10) Pub. No.: US 2010/0169180 A1
(43) Pub. Date: Jul. 1, 2010

(54) ON-LINE GARAGE SALE

(75) Inventors: Venmal Arasu, Cupertino, CA (US); Bruce Robert Abbott, Salem, MA (US)

Correspondence Address: SCHWEGMAN, LUNDBERG & WOESSNER/EBAY, P.O. BOX 2938, MINNEAPOLIS, MN, 55402, US

(73) Assignee: EBAY INC., SAN JOSE, CA (US)

(21) Appl. No.: 12/347,931

(22) Filed: Dec. 31, 2008

(51) Int. Cl. G06Q 30/00; G01C 21/34

(52) U.S. Cl. 705/14.55; 705/26; 705/27; 701/202; 705/14.73

(57) ABSTRACT

One example embodiment relates to a method that comprises receiving a request from a user via a computer network to list of one or more items on the computer network that are part of a garage sale; and providing advertising to the user that indicates where the items in the garage sale may be found using the computer network. Another example embodiment relates to a system that comprises a communication module connected to a computer network; the communication module being adapted to receive a request from a user to list items that are part a garage sale; a multiple listing engine that receives data relating to the items from the user and lists the items for sale on the communication network; and an advertisement that includes information as to where buyers can view the items that are part of the garage sale on the communication network.

### FIELD

This application relates generally to garage sales, and more specifically to systems and methods for on-line marketplace listings of items in a garage sale.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2008, EBAY, INC., all Rights Reserved.

### BACKGROUND

Garage sales are a common way for people to buy and sell goods. Most garage sales are conducted by placing signs in the neighborhood where the garage (i.e., rummage) sale is being held. Some people also often advertise in the local newspaper or church bulletin as a way to increase attendance at their garage sale.

### BRIEF DESCRIPTION OF DRAWINGS

Embodiments are illustrated by way of example and not limitation in the figures of the accompanying drawings. Like reference numbers indicate similar elements.

FIG. 1 is a block diagram illustrating an example embodiment of an architecture within which systems and methods for on-line marketplace listings of items in a garage sale may be executed.

FIG. 2 is a perspective view illustrating an example embodiment of a yard sign.

FIG. 3 is a perspective view illustrating an example embodiment of a brochure.

FIG. 4 is a block diagram illustrating an example embodiment of a system for on-line marketplace listings of items in a garage sale.

FIGS. 5A-5C are screenshots illustrating example marketplace listings of items in a garage sale displayed on an electronic device.

FIG. 6 is a flow chart illustrating an example embodiment of a method for on-line marketplace listings of items in a garage sale.

FIG. 7 is a diagrammatic representation illustrating an example machine in the form of a computer system within which a set of instructions for causing the machine to perform a portion of any one or more of the methodologies discussed herein may be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

Some example embodiments of systems and methods for on-line marketplace listings of items in a garage sale are described herein. The systems and methods may serve to improve the experience of sellers conducting garage sales.

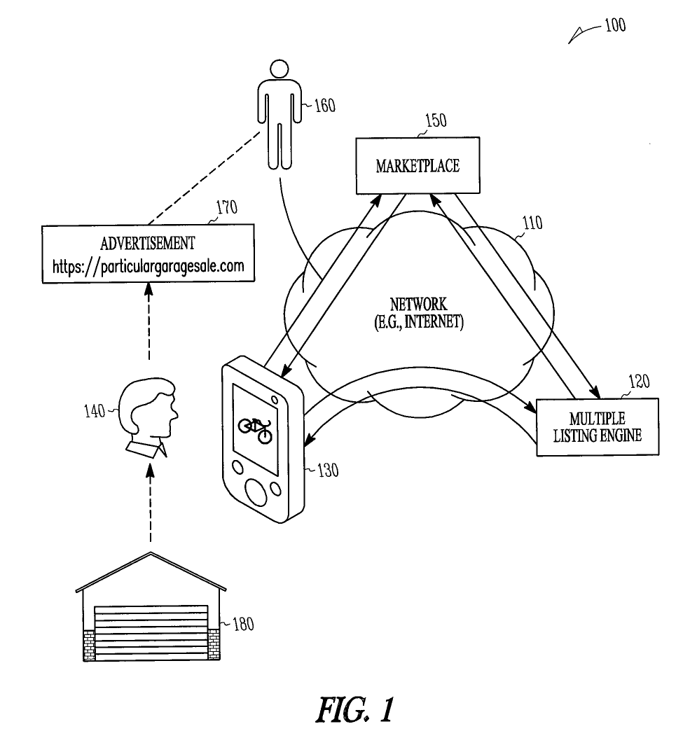

FIG. 1 illustrates an example network environment 100 that may include a computer network 110, a multiple listing engine 120, an electronic device 130, a user 140, an electronic marketplace 150, buyers 160, an advertisement 170 and a garage sale 180. The network 110 may comprise a plurality of data processing nodes interconnected for the purpose of data communication. The electronic device 130 may include a desktop computer, laptop computer, mobile device (e.g., cell phone, PDA, global positioning system) or any other electronic device that is capable of interacting with the computer network 110. The electronic device 130 may include a Graphical User Interface (GUI) that can be manipulated by the user 140. The GUI may offer text menus or require typed commands. In alternative forms, the electronic device 130 may be configured to utilize icons in conjunction with text, labels or text navigation to represent the information and actions available to the user 140.

The user 140 may be a person interacting with the electronic device 130 via the GUI. The electronic marketplace 150, in the context of the illustrated example network environment 100, may be an online auction and/or a fixed-price shopping website configured to permit individual users and businesses to buy and sell goods and services (e.g., eBay). The electronic marketplace 150 may be a part of worldwide electronic commerce, which includes buying and selling of products or services over electronic systems such as the Internet and other computer networks.

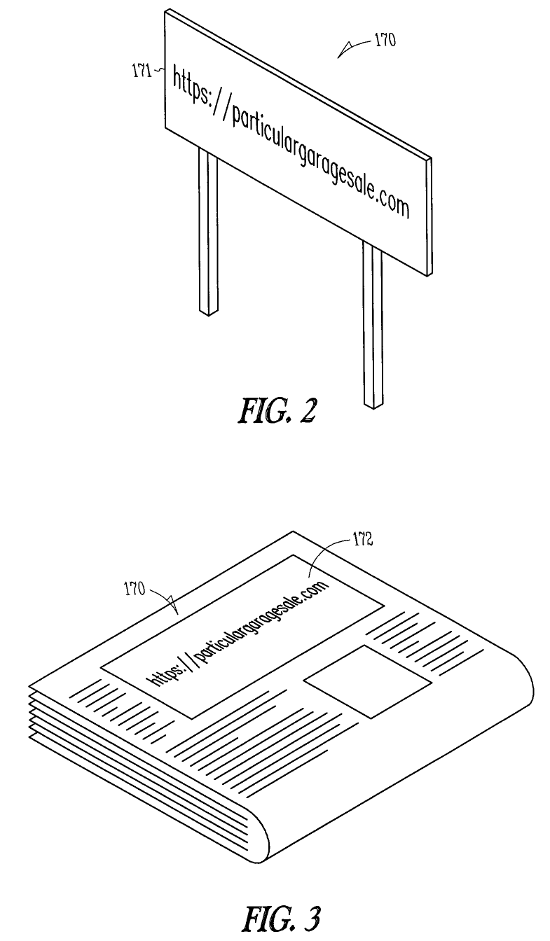

The advertisement 170 includes information as to where buyers 160 can view the items that are part of the garage sale 180 on the computer network 110. As examples, the advertisement 170 may be a yard sign (see FIG. 2), a brochure (see FIG. 3), a banner, or some other form of advertising that would provide information to the potential buyers that are near the garage sale 180. The particular information on the advertisement 170 that lets buyers 160 know where they can view the items that are part of the garage sale 180 on the computer network 110 may take the form of a web address (e.g., https://particulargaragesale.com).

In some embodiments, the advertisement 170 includes information related to preferred purchasing opportunities that are available to buyers 180 when using the information contained in the advertisement 170 to access the listing on the computer network 110. As examples, user 140 may (i) offer the ability to purchase the items via the computer network 110 before the actual start of the garage sale 180; and/or (ii) provide a purchasing incentive (e.g., a discount) for people that use the computer network 110 to purchase any of the items that are part of the garage sale 180.

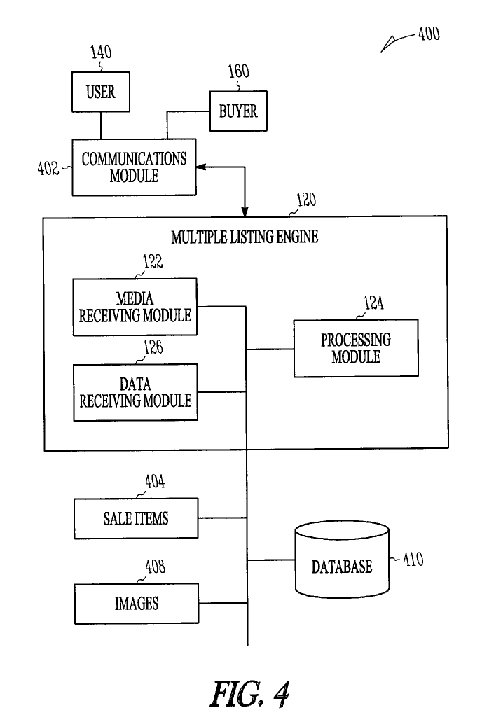

Referring now also to FIG. 4, which is a block diagram that shows an example system 400 for displaying on-line marketplace listings of items in a garage sale 180. The system 400 includes a communication module 402 coupled to a multiple listing engine 120.

The system 400 may further include sale items 404, images 408, and a database 410. The communication module 402 is configured to receive a request from a user 140 to list one or more sale items 404 on the computer network 110 that are part the garage sale 180.

The multiple listing engine 120 may include various components that facilitate listing the sale items 404 on the electronic marketplace 150. As an example, the multiple listing engine 120 may include a media receiving module 122, a processing module 124 and a data receiving module 126. The data receiving module 126 may be configured to receive data from the user 140 or the database 410. The database 410 may include data that is associated with the sale items 404 and/or the garage sale 180 (e.g., location and hours of operation).

In some embodiments, the processing module 124 may be configured to list the sale items 404 for sale. In addition, the database 410 may be a single database, or a combination of databases that are configured as a structured collection of records or data. The relevant data may be stored in the electronic device 130 and/or another electronic device that is connected the computer network 110 (e.g., an electronic device that forms parts of the electronic marketplace 150).

The communication module 402 is able to receive requests from buyers via the computer network 110 to review the listing. The relevant information is obtained from the database 410 once the buyer 160 accesses the multiple listing engine 120 through the communication module 402 using the information in the advertisement 170.

As discussed above, the database 410 (or databases) may store information related to purchasing preferences for buyers 160 that view the listing using the information provided in the advertisement 170. In some embodiments, the information related to purchasing preferences for buyers 160 that view the listing using the information provided in the advertisement 170 may be obtained from another database (not shown in FIGS.) that can be accessed via the computer network 110.

In some embodiments, the media receiving module 122 may be configured to receive the images 408 over the computer network 110 that are associated with the sale items 404. The user 140 may supply the images 408 via the electronic device 130. Depending on the type of data that is provided by the user 140 for the sale items 404, the sale items 404 may be extracted from images 408 that are received by the media receiving module 122 and/or the data that is received by the data receiving module 126.

The data in the database 410 may be utilized in creating the listing of the items 404 by the multiple listing engine 120, or in response to a query by a buyer 160 for items on marketplace 150 that are part of the garage sale 180. In addition, the database 410 may store the images 408 as well as any other data that is associated with the sale items 404.

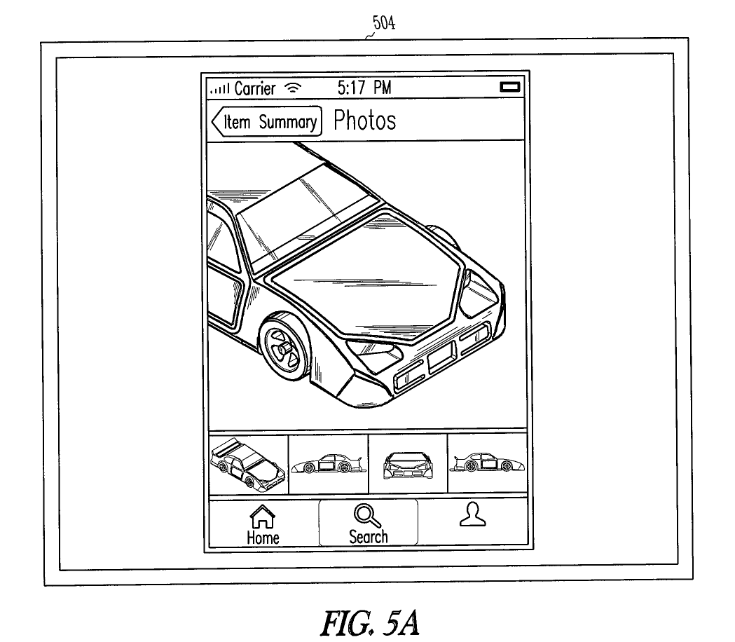

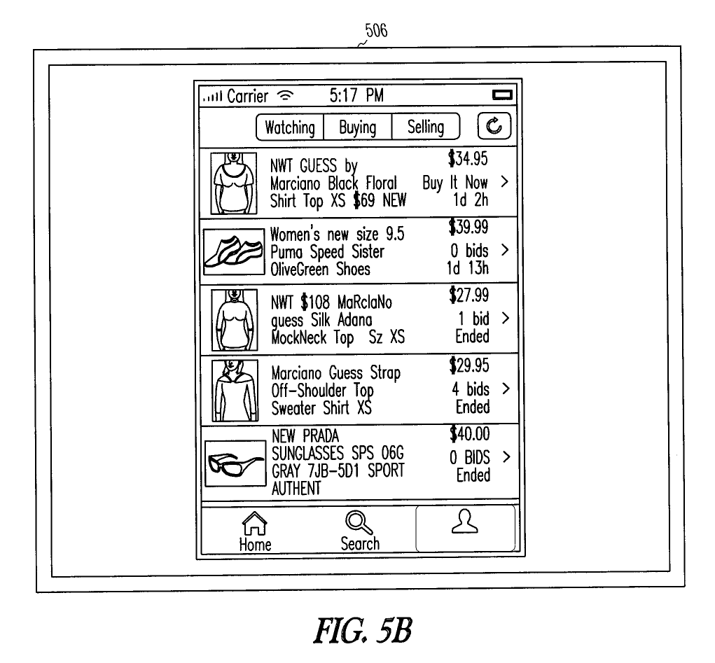

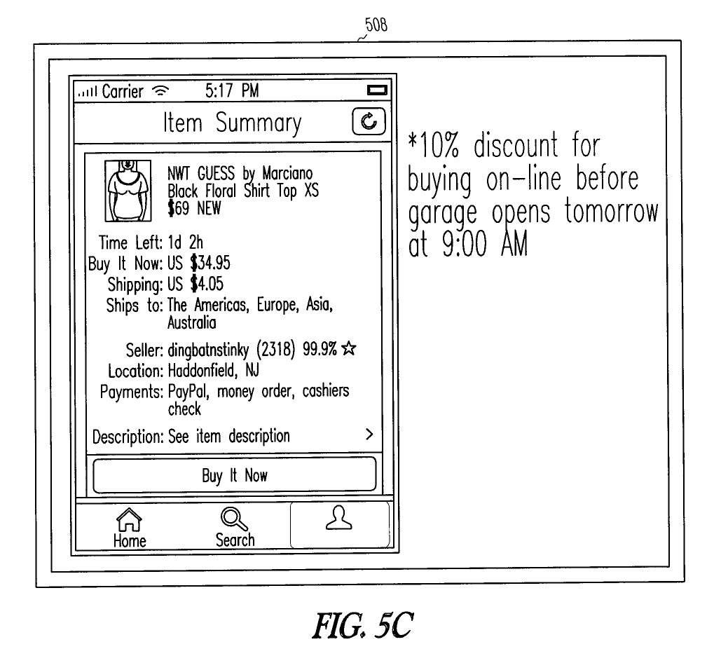

FIGS. 5A-5C illustrate some example screenshots showing marketplace listings displayed on the electronic device 130. The illustrated screenshots include photos 504 (FIG. 5A), multiple listings 506 (FIG. 5B), and an item summary 508 (FIG. 5C). It should be noted that any of the photos 504, multiple listings 506, and item summary 508 may reference the garage sale 180 and/or any preferred purchasing opportunities. In the illustrated example embodiment, the item summary 508 displays information 510 that references the garage sale 180 and preferred purchasing opportunities.

The photos 504 show images 408 that may be supplied to the marketplace 150 by the user 140. The multiple listings 506 shows sale items 404 that may have been extracted from the database 410 based on a query received from a potential buyer 160. The sale items 404 in the listings 506 may be extracted from the database 410 along with the relevant images 408. The item summary 508 shows the summary of one item shown in the multiple listings 506.

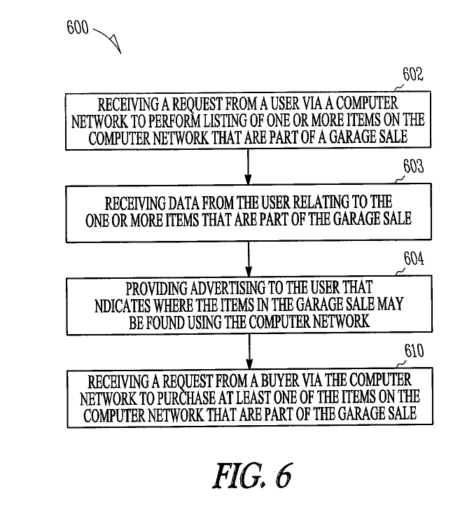

FIG. 6 illustrates an example method 600 for on-line marketplace listings of items in a garage sale 180. Some portions of the method 600 may be performed by processing logic that may comprise hardware (e.g., dedicated logic, programmable logic, microcode, etc.), software (such as that which may be run on a general-purpose computer system or a dedicated machine), or a combination of both.

In one example embodiment, the processing logic resides at the multiple listing engine 120, illustrated in FIG. 4. Some portions of the method 600 may be performed by the various example modules discussed above with reference to FIG. 4. Each of these modules may comprise processing logic.

As shown in FIG. 6, the method 600 commences at operation 602, with the communication module 402 receiving a request from user 140 via a computer network 110 to perform listing of one or more sale items 404 on the computer network 110 (e.g., on the market place 150) that are part of the garage sale 180. The method 600 further includes at operation 604, providing advertising to the user 140 that indicates where the items 404 in the garage sale 180 can be found using the computer network 110.

In some embodiments, the operation 604 of providing advertising to the user 140 includes providing an advertisement 170 that includes a web address where the sale items 404 in the garage sale 180 can be viewed using the computer network 110. In addition, providing an advertisement 170 that includes a web address where the sale items 404 in the garage sale 180 can be viewed using the computer network 110 can include providing a yard sign 171 (see FIG. 2), a brochure 172 (see FIG. 3), a banner, or some other form of advertising.

Other embodiments are contemplated where the operation 604 of providing advertising to the user 140 includes (i) providing advertising which indicates that buyers 160 utilizing the web address get preferred opportunities to purchase any of the one or more sale items 404 on the computer network 110 that are part of the garage sale 180; (ii) providing advertising that presents direction to a geographic location of the garage sale 180; and/or (iii) shipping advertising materials to a location specified by the user 140.

In some embodiments, the method 600 further includes operation 603 where the media receiving module 122 and the data receiving module 126 of the multiple listing engine 120 receive images 408 and/or data from the user 140 relating to the one or more sale items 404 that are part of the garage sale 180. The processing module 124 can list the one or more sale items 404 on the computer network 110 such that images 408 and data associated with the one or sale items 404 is displayed as part of the listing.

The pertinent data can be supplied by the user 140 to the communication module 402 using any type of electronic device 130. Some example electronic devices 130 include a desktop computer, laptop computer, mobile device (e.g., cell phone, PDA, global positioning system) or any other electronic device that is capable of interacting with the computer network 110 to provide data and/or images.

In some embodiments, the method further includes operation 610, where the communication module 402 receives a request from a buyer 160 via the computer network 110 to purchase at least one of the sale items 404 on the computer network 110 that are part of the garage sale 180. The multiple listing engine 120 then retrieves the appropriate data and displays the listing along with the rest of information that pertains to the listing (e.g., image, description, any preferred purchasing opportunities, and/or any other information relevant to the garage sale 180). In some embodiments, the operation 610 of receiving the request from the buyer 160 to purchase at least one of the sale items 404 that are part of the garage sale 180 includes receiving the request from the buyer 160 before the garage sale 180 has begun.

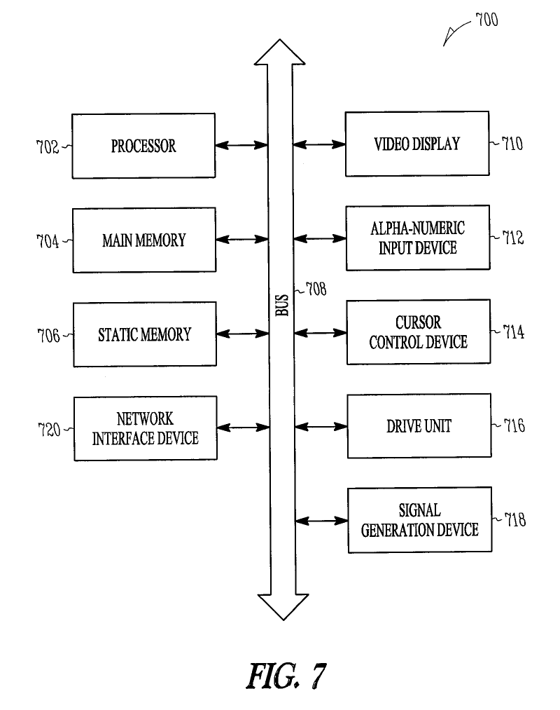

FIG. 7 illustrates an example computer system 700 that may be used as part of the systems and methods described herein. The example computer system 700 includes a processor or multiple processors 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 may also include an alphanumeric input device 712 (e.g., a keyboard), a cursor control device 714 (e.g., a mouse), a disk drive unit 716, a signal generation device 718 (e.g., a speaker) and a network interface device 720.

Thus, systems and methods for on-line marketplace listings of items in a garage sale have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method comprising:
receiving a request from a user via a computer network to list one or more items on the computer network that are part of a garage sale; and
providing advertising to the user that indicates where the items in the garage sale can be found using the computer network.

2. The method of claim 1 further comprising receiving data from the user relating to the one or more items that are part of the garage sale.

3. The method of claim 1, wherein receiving data from the user relating to the one or more items that are part of the garage sale includes receiving images corresponding to the one or more items that are part of the garage sale.

4. The method of claim 1, wherein providing advertising to the user includes providing an advertisement that includes a web address where the items in the garage sale can be viewed using the computer network.

5. The method of claim 1, wherein providing an advertisement that includes a web address where the items in the garage sale can be viewed using the computer network includes providing a yard sign that includes a web address where the items in the garage sale can be viewed using the computer network.

6. The method of claim 1, wherein providing an advertisement that includes a web address where the items in the garage sale can be viewed using the computer network includes providing a brochure that includes a web address where the items in the garage sale can be viewed using the computer network.

7. The method of claim 1, further comprising receiving a request from a buyer via the computer network to purchase at least one of the items on the computer network that are part of the garage sale.

8. The method of claim 7, wherein receiving the request from the buyer to purchase at least one of the items that are part of the garage sale includes receiving the request from the buyer before the garage sale has begun.

9. The method of claim 7, wherein providing advertising to the user includes providing advertising which indicates that buyers utilizing the web address get preferred opportunities to purchase any of the one or more items on the computer network that are part of a garage sale.

10. The method of claim 1, wherein providing advertising to the user that indicates where the items in the garage sale can be found using the computer network includes providing advertising that presents direction to a geographic location of the garage sale.

11. The method of claim 1, wherein providing advertising to the user that indicates where the items in the garage sale can be found using the computer network includes shipping advertising materials to a location specified by the user.

12. A garage sale system comprising:
a communication module connected to a computer network; the communication module being adapted to receive a request from a user to list one or more items that are part a garage sale;
a multiple listing engine that receives data relating to the one or more items from the user and lists the items for sale on the communication network based on the data; and
an advertisement that includes information as to where buyers can view the items that are part of the garage sale on the communication network.

13. The garage sale system of claim 12, wherein the multiple listing engine receives images in the data that correspond to the one or more items which are part of the garage sale and displays the images as part of the listing.

14. The garage sale system of claim 12, wherein the advertisement includes information related to preferred purchasing opportunities for buyers that view the listing on the computer network.

15. The garage sale system of claim 12, wherein the advertisement is a yard sign.

16. The garage sale system of claim 12, wherein the advertisement is a brochure.

17. An apparatus for conducting a garage sale, the apparatus comprising:
means for receiving a request over a computer network to list one or more items that are part of the garage sale;
means for receiving data associated with the one or more items over the computer network;
means for listing the one or more items on the computer network based on the data; and
means for displaying information as to where the items in the garage sale may be viewed using the computer network.

18. The garage sale system of claim 17, wherein the means for receiving data associated with the one or more items over the computer network includes means for receiving images associated with the one or more items over the computer network.
